(19) United States
(12) Patent Application Publication
(10) Pub. No.: US 2026/0343130 A1
(43) Pub. Date: Oct. 29, 2026

(54) EAR-WORN HEARING DEVICE WITH IN-EAR MICROPHONE

(71) Applicant: KNOWLES ELECTRONICS, LLC, ITASCA, IL (US)

(72) Inventor: DONALD VERGHESE JACOB, CHICAGO, IL (US)

(21) Appl. No.: 19/387,924

(22) Filed: Nov. 13, 2025

Related U.S. Application Data
(60) Provisional application No. 63/724,043, filed on Nov. 22, 2024.

(51) Int. Cl. H04R 1/10; H04R 1/02; H04R 25/00

(52) U.S. Cl. CPC H04R 1/1016; H04R 1/023; H04R 1/1083; H04R 25/604; H04R 25/65; H04R 2201/003; H04R 2460/01

(57) ABSTRACT

A hearing device including a spout configured for wearing on a user's concha or at least partially in a user's ear canal is disclosed. The hearing device includes a speaker having a sound outlet acoustically coupled to an opening of the spout by a speaker sound path, and a microphone mounted on a carrier. The microphone includes a manifold forming microphone sound path acoustically coupling the microphone to the spout opening, wherein the manifold isolates the microphone sound path from a speaker sound path along at least a portion of the spout passage.

### CROSS REFERENCE TO RELATED APPLICATION

This is a non-provisional application for patent entitled to a filing date and claiming the benefit of earlier-filed U.S. Provisional Patent Application No. 63/724,043, filed Nov. 22, 2024, herein incorporated by reference in its entirety.

### FIELD OF THE DISCLOSURE

The present disclosure relates generally to ear-worn hearing devices and more particularly to ear-worn hearing devices comprising a speaker and in-ear microphone, and subassemblies and components for such hearing devices.

### BACKGROUND

Some ear-worn hearing devices comprise a speaker disposed in a housing having a nozzle configured for at least partial insertion in a user's ear canal. One such device is a receiver-in-canal (RIC) hearing aid. Advances in audio signal processing, miniaturization, reductions in power consumption, and lower costs have spurred increasing adoption of active noise cancellation (ANC) and other audio enhancing functionality in ear-worn hearing devices. These audio enhancing features benefit from a microphone capable of sensing conditions within the user's ear. As such, a sound path of the speaker can interfere with a sound path of the microphone. Also, proper integration of these and other components with the hearing device is difficult and improper assembly can result in performance issues and increased costs. Thus, there is an ongoing need for improved ear-worn hearing devices, sub-assemblies, and components therefor.

### BRIEF DESCRIPTION OF THE DRAWINGS

The objects, features and advantages of the present disclosure will become more fully apparent upon consideration of the following detailed description and appended claims in conjunction with the accompanying drawings. The drawings depict only representative embodiments and implementations and are not considered to limit the teachings of the disclosure, the scope of which is set forth by the appended claims.

FIG. 1 is a representative ear-worn hearing device comprising an ear-worn unit connected to a base unit by an electrical cable.

FIG. 2 is a partial sectional view of a representative ear-worn hearing device comprising a carrier supporting a microphone having a manifold.

FIG. 3 is a perspective view of a representative carrier.

FIG. 4 is an exploded view of a representative microphone and manifold assembly.

FIG. 5 is a sectional view of a representative microphone and manifold assembly.

FIG. 6 is a sectional view along lines a-a of FIG. 2.

Those of ordinary skill in the art will appreciate that the drawings are illustrated for simplicity and clarity and therefore may not be drawn to scale and may not include well-known features, that the order of occurrence of actions or steps may be different than the order described, that some or all of such actions or steps may be performed concurrently unless specified otherwise, and that the terms and expressions used herein have meaning understood by those of ordinary skill in the art except where a different meaning is specifically attributed to them.

### DETAILED DESCRIPTION

The disclosure relates generally to ear-worn hearing devices comprising a speaker and an in-ear microphone, and hearing device subassemblies and components for hearing devices. Such hearing devices include, but are not limited to, receiver-in-canal (RIC) devices, in-the-ear (ITE) devices, in-the-canal (ITC) devices, and true wireless stereo (TWS) devices, among other earphones and hearing devices worn on a user's concha or at least partially in a user's ear canal. Representative implementations are described herein.

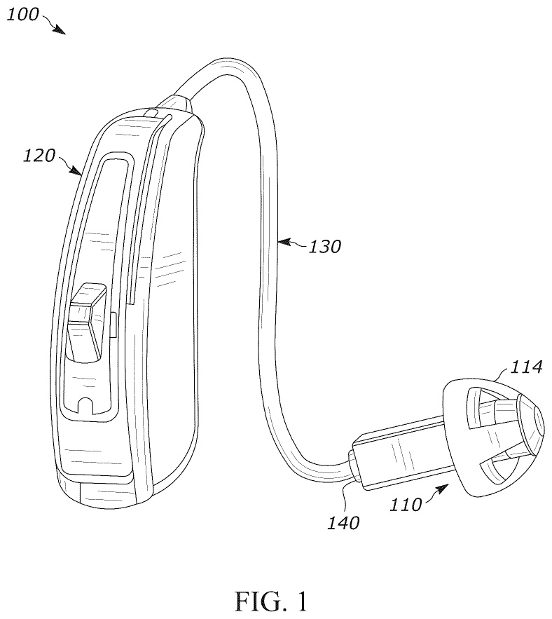

FIG. 1 is a representative ear-worn hearing device 100 comprising an ear-worn unit 110 connected to a base unit 120 by an electrical cable 130. The electrical cable comprises a first end portion connected to an interface 140 of the ear-worn unit and a second end portion comprises a connector releasably or permanently connected to the base unit. The first end portion of the electrical cable is electrically connected to one or more electrical components (e.g., speaker or sensor) of the ear-worn unit. The second end portion of the electrical cable is electrically connected, or connectable, to electrical components (e.g., processor or other electrical circuits) of the base unit. An ear-worn unit alone or in combination with the electrical cable 130 is also referred to herein as a “receiver-in-canal (RIC) unit” or a “speaker component”. A resilient ear dome 114 can be connected to a ribbed spout to support the ear-worn unit at least partially in a user's ear canal.

The ear-worn unit generally comprises one or more speakers that generate sound in response to an electrical audio signal provided by the base unit. The one or more speakers can be balanced armature receivers (also referred to herein as “receivers”) or dynamic speakers, or a combination thereof. Receivers generally comprise a diaphragm separating an interior of a speaker housing into a back volume and a front volume comprising a sound outlet, and a motor comprising an armature having a movable end portion linked to the diaphragm. Receivers are also known as moving iron speakers since the armature moves relative to a fixed coil. In dynamic speakers (also known as moving coil speakers), the coil is coupled to, and moves, with the diaphragm. Receivers have relatively small size and efficiency making them particularly suitable for use in hearing devices configured for wearing in or partially in the user's ear canal (e.g., RIC and ITC devices). Hearing devices configured for wear on the concha generally have more space to accommodate multiple receivers and dynamic speakers.

In FIG. 1, the representative base unit 120, also referred to herein as a behind-the-ear (BTE) unit or component, is configured for wearing on a back side of the user's ear. Alternatively, the base unit can be configured for wear on or around some other body portion, e.g., the head, neck, or arm, among other body parts. The base unit generally comprises a processor and other circuits, one or more microphones, and a battery. The base unit can also comprise a wireless transceiver among other circuits and components. Thus configured, the base unit can detect acoustic signals and generate and process (e.g., suppress noise, amplify sound, etc.) electrical audio signals produced by the one or more microphones in response to detecting the acoustic signals. The electrical audio signals are transmitted to the ear-worn unit 110 via the electrical cable 130.

In other ear-worn hearing devices, the components and functionality of the ear-worn unit and base unit described herein are integrated in a unitary ear-worn hearing device. Such hearing devices can be implemented as ITE, ITC, and TWS devices, among other earphones and devices configured for wearing on the concha or at least partially in a user's ear canal. These and other ear-worn hearing devices may or may not include a resilient ear dome. More generally, the configuration of the ear-worn hearing device and configuration of speakers, microphones or other sensors therein depends on whether the device is configured for wearing on the concha, partially in, or more fully in the user's ear canal.

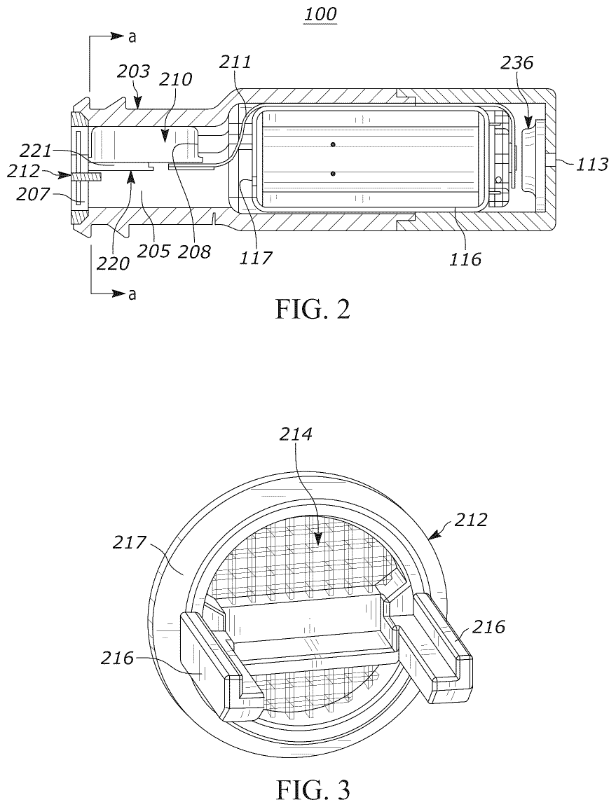

The one or more speakers are at least partially disposed in a housing of the hearing device comprising a spout configured for wearing on the user's concha or at least partially in the user's ear canal. In FIGS. 1 and 2, the speaker is fully encapsulated by the housing. In other implementations, an exposed portion of the speaker housing can be an exterior of the hearing device. In any case, a sound outlet of the one or more speakers is acoustically coupled to an opening of the spout by a speaker sound path extending through a passage of the spout. In FIG. 2, a representative ear-worn hearing device 110 comprises a receiver 116 at least partially disposed in a hearing device housing 112 having a spout 203 configured for at least partial insertion in the user's ear canal. The spout can comprise a flatter lobe or other shaped portion that faces the user's ear for hearing devices configured for wearing on the concha. The spout comprises a passage terminating at an opening 207 of the spout. A speaker sound path 205 extends between a sound outlet 117 of the speaker and the opening 207 of the spout.

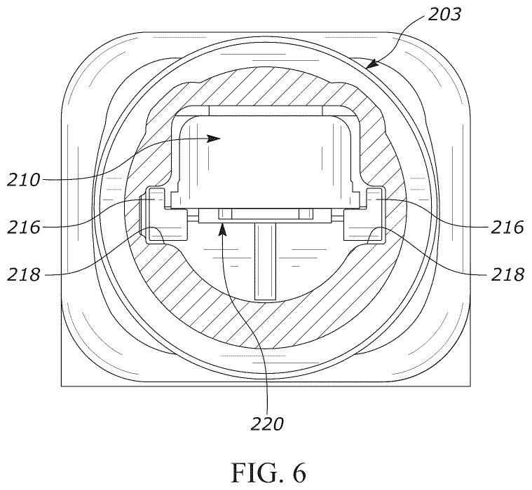

The ear-worn hearing device also comprises a microphone located to detect sound in the user's ear (the “in-ear microphone”). The microphone is acoustically coupled to the opening of the spout by a microphone sound path as described further herein. In FIGS. 2 and 6, a microphone 210 is disposed in the passage of the spout 203 between the spout opening 207 and the one or more speakers 116. In FIG. 2, a flex circuit or other conductor 211 connects the microphone 210 to an electrical interface or other circuits of the hearing device. Additional sensors can also be integrated with the hearing device. In FIG. 2, a second microphone 236 located in the hearing device housing 112 is acoustically coupled to a sound opening 113 for detecting sounds originating outside the user's ear. In some hearing devices, the microphone for detecting sound outside the ear can be integrated with a BTE unit instead of, or in addition to, the speaker unit, as described herein. In other implementations, the additional sensor can be a vibration sensor located to detect vibrations propagated through the user's body. A sound port is not required for a vibration sensor integrated with the ear-worn hearing device.

Ear-worn hearing devices comprising an in-ear acoustic sensor can provide enhanced audio performance. An in-ear microphone can be used alone or in combination with another microphone or sensor to detect ambient sound and to improve noise and reduce occlusion. The in-ear microphone can also be used as a probe to obtain real-ear-to-coupler difference (RECD) measurements for customized hearing device fitting, among other uses. An in-ear vibration sensor can be used to detect speech from the user of the hearing device. Such speech detection can be used for ANC and other audio enhancement features.

In FIG. 2, the microphone 210 is assembled with a carrier 212 comprising an interface portion disposed in the passage of the spout 203. The interface portion supports the microphone and locates the carrier in the passage of the spout. In FIG. 3, the representative carrier 212 comprises arms 216 on which the microphone can be mounted. Alternatively, the carrier can comprise at least a single arm or shelf on which the microphone is mounted, wherein the one or more arms or shelf is insertable into a complementary receptacle of the spout passage. In FIG. 6, the arms are disposed in corresponding recesses or receptacles 218 of the spout passage when the carrier is assembled with the spout. The recesses or receptacles locate and guide insertion of the carrier into the spout passage during assembly. The microphone can be fastened to the carrier by glue, heat staking or some other fastening mechanism. Thus configured, the microphone and the carrier form a subassembly that can be disposed in the passage of the spout, shown in FIGS. 2 and 6, to facilitate integration of the carrier and microphone subassembly with the spout.

In FIG. 3, the carrier optionally comprises a sound-permeable mesh 214 to reduce contaminant ingress and a frame 217 fastened at least partially about a perimeter of the sound-permeable mesh 214. The arms 216 are integrated with the frame and extend away from the mesh. In FIG. 2, the frame is seated on a portion of the spout to locate the mesh over the opening of the passage and to position the microphone in the spout. The frame provides additional support for the sound-permeable mesh, facilitates handling and location of the mesh during assembly, and provides greater surface area for contact with the spout. The frame and mesh can be formed as a unitary molded member. Alternatively, the frame can be molded over the sound-permeable mesh, or the mesh can be insert molded within the frame, to accommodate different materials or hardnesses. In the absence of the carrier frame, a backwall portion or stops in the recesses or receptacles can arrest insertion of the carrier and microphone subassembly into the passage to ensure proper positioning therein.

The microphone sound path extends through the passage of the spout and acoustically couples a sound port of the microphone to the spout opening. In FIG. 2, the microphone sound path acoustically couples the microphone 210 and the spout opening 207. A manifold 220 coupled to the microphone comprises a sound passage 221 between the sound port of the microphone and an opening of the manifold, as described further herein. The sound passage 221 of the manifold forms at least a portion of the microphone sound path. An exterior of the manifold forms a boundary between the speaker sound path and the microphone sound path. In FIG. 2, the sound path of the manifold extends fully to the opening of the spout to maximize separation of the microphone and speaker sound paths. Alternatively, the speaker sound path and the microphone sound path can be partially separated by a partition in the passage of the spout proximate the spout opening. The sound passage of the manifold extends to the partition. Isolation of the microphone sound path from the speaker sound path along at least a portion of the spout passage reduces undesirable feedback and other adverse effects resulting from mixing of the microphone signal and the speaker signal.

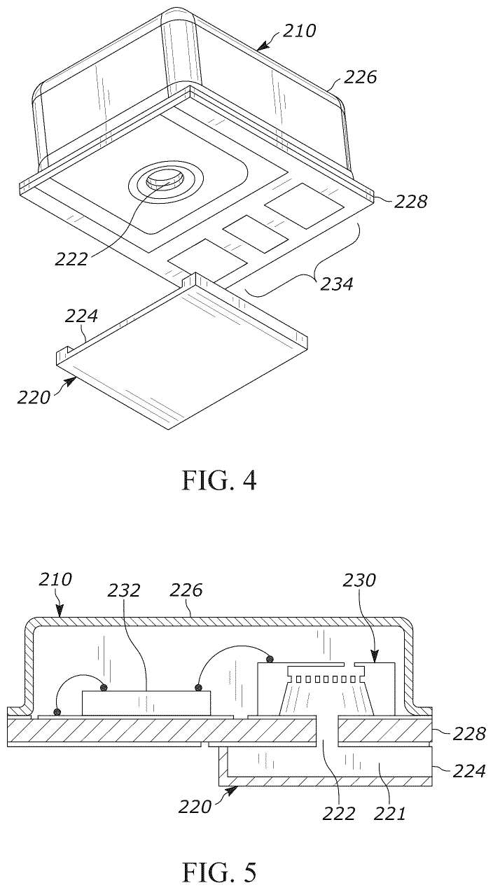

In FIGS. 4 and 5, a representative microphone 210 comprises a manifold 220 fastened to an exterior of the microphone and covering a sound port 222 of the microphone. The manifold comprises a sound passage 221 between the sound port 222 of the microphone and an opening 224 of the manifold, shown best in FIG. 5. The manifold can be fastened to the microphone to form a subassembly to facilitate integration with the carrier.

The representative microphone comprises a transducer and an electrical circuit disposed in a housing having an external interface. In FIGS. 4 and 5, the microphone 210 comprises a housing including a cover 226 mounted on a base 228. The manifold 220 is mounted on the base 228 and can be fastened thereto by glue, solder, or some other fastening mechanism. A transducer 230 disposed in the housing is mounted on the base over the sound port 222. The representative transducer is a capacitive device comprising a diaphragm movable relative to a fixed backplate. Alternatively, the transducer can be a piezoelectric or other transduction device. These and other transducers can be microelectromechanical (MEMS) devices. An electrical circuit 232 also disposed in the housing is electrically coupled to the transducer and to an electrical interface 234 of the housing shown in FIG. 4. In FIGS. 4 and 5, a direction of the sound port 222 is non-parallel to a direction of the sound passage 221 of the manifold. The direction of the sound port refers to a predominant direction at which sound enters the housing of the microphone. In other implementations, depending on the type and configuration of the microphone, the direction of the sound port can be at least partially aligned with the direction of the sound port.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is claimed is:

1. An ear-worn hearing device comprising:
a spout configured for wearing on a user's concha or at least partially in a user's ear canal, the spout comprising a passage extending to an opening of the spout;
a speaker comprising a sound outlet acoustically coupled to the opening of the spout by a speaker sound path;
a carrier comprising an interface portion insertable into the passage of the spout;
a microphone assembled with the carrier and acoustically coupled to the opening of the spout by a microphone sound path;
wherein the microphone is positioned in the passage of the spout when the interface portion of the carrier is inserted into the passage.

2. The ear-worn hearing device of claim 1, wherein the microphone is located within the passage of the spout and between the spout opening and the speaker.

3. The ear-worn hearing device of claim 1, the carrier further comprising a frame fastened at least partially about a perimeter of a sound-permeable mesh, and the interface portion comprising an arm integrated with the frame and extending from the sound-permeable mesh into a receptacle of the spout, wherein the sound-permeable mesh covers the spout opening when the arm of the carrier is inserted into the passage.

4. The ear-worn hearing device of claim 1 further comprising a manifold covering a sound port of the microphone, a sound passage of the manifold forming at least a portion of the microphone sound path, wherein the manifold isolates the microphone sound path from the speaker sound path along at least a portion of the spout passage.

5. The ear-worn hearing device of claim 4, wherein the manifold extends to the spout opening.

6. The ear-worn hearing device of claim 4, wherein the microphone comprises a microphone housing with an electrical interface, the sound port extends through the microphone housing, and the manifold is fastened to the housing over the sound port.

7. The ear-worn hearing device of claim 6, wherein the microphone comprises a microelectromechanical systems (MEMS) transducer and an electrical circuit disposed in the microphone housing, the electrical circuit electrically connected to the MEMS transducer and to the electrical interface, wherein a direction of the sound port of the microphone is non-parallel to a direction of the sound passage of the manifold.

8. An ear-worn hearing device comprising:
a housing comprising a spout configured for at least partial insertion in a user's ear canal, the spout comprising a passage extending to an opening of the spout;
a speaker disposed in the housing and comprising a sound outlet acoustically coupled to the spout opening by a speaker sound path extending through the passage of the spout;
a carrier comprising a frame fastened at least partially about a perimeter of a sound-permeable mesh;
a microphone assembled with the carrier and comprising a manifold covering a sound port acoustically coupled to the opening of the spout by a microphone sound path extending through the manifold,
wherein the sound-permeable mesh covers the spout opening and the microphone is positioned in the passage of the spout when an interface portion of the carrier is inserted into the passage.

9. The ear-worn hearing device of claim 8, the manifold comprising a sound passage between the sound port of the microphone and an opening of the manifold, wherein the manifold isolates the microphone sound path from the speaker sound path along at least a portion of the spout passage.

10. The ear-worn hearing device of claim 9, wherein the manifold extends to the spout opening.

11. The ear-worn hearing device of claim 10, the interface portion of the carrier comprises an arm integrated with the frame and extending away from the sound-permeable mesh into a receptacle of the spout, wherein the interface portion locates the carrier relative to the spout.

12. The ear-worn hearing device of claim 11, wherein the microphone comprises a microphone housing with an electrical interface, the sound port extends through the microphone housing, and the manifold is fastened to the housing over the sound port.

13. The ear-worn hearing device of claim 12, wherein the manifold is fastened to the microphone over the sound port, and direction of the sound port is non-parallel to a direction of the sound passage of the manifold.

14. The ear-worn hearing device of claim 13, wherein the microphone comprises a microelectromechanical systems (MEMS) transducer and an electrical circuit disposed in the microphone housing, the electrical circuit electrically connected to the MEMS transducer and to the electrical interface.

15. The ear-worn hearing device of claim 8 further comprising a second microphone disposed in the housing and acoustically coupled to an exterior of the housing.

16. The ear-worn hearing device of claim 14 is a receiver-in-canal (RIC) unit further comprising an electrical cable having a first end portion electrically connected to an electrical component of the RIC unit and a second end portion comprising an electrical connector.

17. An ear-worn hearing device subassembly for a receiver-in-canal (RIC) hearing device comprising a speaker disposed in a housing having a spout configured for at least partial insertion in a user's ear canal, the ear-worn hearing device subassembly comprising:
a carrier comprising a frame fastened at least partially about a perimeter of a sound-permeable mesh and an interface portion; and
a microphone comprising a manifold disposed over a sound port of the microphone, the microphone mounted on the interface portion of the carrier,
wherein the sound-permeable mesh covers a sound opening of the spout, the microphone is positioned in a passage of the spout, and the manifold at least partially isolates a sound path of the microphone from a sound path of the speaker when the carrier is assembled with the RIC hearing device.

18. The ear-worn hearing device subassembly of claim 17, the interface portion of the carrier comprises an arm integrated with the frame and extending away from the sound-permeable mesh, wherein the arm is extendable into a receptacle of the spout when the carrier is assembled with the RIC hearing device.

19. The ear-worn hearing device subassembly of claim 18, wherein the microphone comprises a microphone housing with an electrical interface, the sound port of the microphone extends through the microphone housing, and the manifold is fastened to the housing over the sound port.

20. The ear-worn hearing device subassembly of claim 19, wherein the microphone comprises a microelectromechanical systems (MEMS) transducer and an electrical circuit disposed in the microphone housing, the electrical circuit electrically connected to the MEMS transducer and to the electrical interface, wherein a direction of the sound port of the microphone is non-parallel to a direction of the sound passage of the manifold.

21. The ear-worn hearing device subassembly of claim 17 further comprising a second microphone disposed in the housing and acoustically coupled to an exterior of the housing exposed to an exterior of a user's ear when the hearing device is worn by the user.
